(19) United States
(12) Patent Application Publication
(10) Pub. No.: US 2005/0099287 A1
(43) Pub. Date: May 12, 2005

(54) Indicator system for vehicles

(76) Inventor: Wen-Wei Su, Guei Shan (TW)

Correspondence Address: TROXELL LAW OFFICE PLLC;SUITE 1404, 5205 LEESBURG PIKE, FALLS CHURCH, VA, 22041, US

(21) Appl. No.: 10/703,535

(22) Filed: Nov. 10, 2003

(51) Int. Cl. B60Q 1/50

(52) U.S. Cl. 340/464; 340/815.45

(57) ABSTRACT

An indicator system for a vehicle is in communication with a control system installed within the vehicle and comprises an indicator display. The indicator display is located at a position a certain distance higher than the bottom edge of the vehicle's rear portion and includes a plurality of LEDs which can present different dynamic patterns indicating different status of the vehicle according to different types of instructions by the control system.

### TECHNICAL FIELD

The present invention relates to an indicator system for vehicles, more particularly to a vehicular indicator system which can present various dynamic indicating signs or signs at a conspicuous position especially for warning or reminding vehicles following behind.

### DESCRIPTION OF RELATED ARTS

A normal indicator system for vehicles usually comprises two sets of indicators positioned apart at the opposite sides of a vehicle's back portion, which are commonly called as first and second set indicators.

The first and second set indicators of the indicator system are commonly used to indicate the turning status of the vehicle, or to warn when the vehicle is braking, backing or breaking down, so that the drivers of vehicles behind may adjust their vehicular speeds or adopt other proper measures accordingly. The first and second indicator system is normally controlled by a controlling system of the vehicle.

One type of said controlling system for vehicle's can refer to U.S. Pat. No. 5,955,944. The controlling system in this patent essentially comprises, in combination, an automobile steering wheel having an annular handle, a hub adapted to be coupled to a steering column of an automobile, spokes disposed about the hub and horizontally extended outward therefrom to the handle, a switch holes or cavities disposed on the hub, and a pair of push buttons located in the switch holes with each push button switch extended through a separate switch hole to thereby define a left push button switch and a right push button switch. Similar controlling systems also include U.S. Pat. No. 6,034,600 and so on which adopt manual control of selectors (in forms of buttons or handle points, etc.) to turn on or off corresponding turn indicators. That means the driver has to push or press the right or left selector when he wants to turn the vehicle in right or left direction, and may also have to return the corresponding selector when the turn is completed. Hence, according turn indicating lamp is turned on or turned off to warn pedestrian or other vehicles around. There are also various automatically controlling systems provided or disclosed in patents and since they are not so closely related to the present invention thereby omitted herewith.

U.S. Pat. No. 6,552,492 (hereinafter as '492) discloses an automatic adverse weather rear light system which automatically activates the adverse weather rear light source or light sources. The adverse weather rear light system comprises a light source or light sources which can increases the conspicuity of the rear of a vehicle during periods of decreased visibility due to either adverse weather, smoke, or dust; a means to collect, receive, and combine the current state of the vehicle, the current environmental conditions, the current visibility conditions, and the current ambient light conditions; a control means whereby the adverse weather rear light system is automatically energized when the current visibility conditions are less than a low visibility threshold limit and wherein the adverse weather rear light system is automatically de-energized when the current visibility conditions are greater than the low visibility threshold limit.

In '492, in order to avoid outshining (masking) either the brake lights or the turn signal/emergency flasher lights, the luminosity of these lights is automatically increased to so that their luminosity is always greater than the luminosity of the adverse weather rear light source or light sources. Thence, the adverse weather rear light system automatically activates and progressively either increases or decreases the luminosity of the adverse weather rear light source or light sources as the current visibility conditions decrease or increase.

However, if the vehicles behind are those whose front portions are very high or big, then the drivers therein can hardly or inconveniently see the blinking indicators of a braking vehicle in front of them since the first and second set indicators are commonly positioned at the below sections of the rear portion of a vehicle. This is very dangerous and it's easy to cause collisions accordingly.

Therefore, the so-called third position brake indicators are designed to be put at a higher position on the rear portion of a vehicle in order to avoid the above collision dangers. Thus, the drivers sitting in those vehicles, whose front portions are high or big as above-mentioned, may conveniently see the blinking brake indicators of vehicles in front of them.

The position of the so-called third brake indicators is usually arranged behind the rear seats in a car and can be seen through the rear window, or is arranged on the top of the rear window and just below the roof of the car. Hence, it is conspicuous when the braking lights thereof are blinking.

However, when the vehicle is braking, the existing third brake indicators normally blink as a whole; and when the braking is ended, the existing third brake indicators black out wholly. It's static and humdrum thereby becoming a disharmonic comparison to the vivid world around. Furthermore, It only lightened when the vehicles is in braking. Thus, a change is needed to be made so as to meet people's demands for the increasingly rich and colorful life and to indicating the various driving conditions.

U.S. Pat. No. 6,573,830 (hereinafter referred as '830) provides a progressive vehicle brake light system consisting of a brake sensor arranged to sense the travel of a brake pedal and a brake light display arranged to illuminate or extinguish in sequence or progressively in response to the travel of the brake pedal. The brake light display consists of a row of light emitting diodes (LEDs) fitted to the rear of the vehicle to display the progressive stages of braking.

The brake light display is arranged such that the LEDs are illuminated progressively from the outer ends towards the middle thereof in response to the amount of pressure applied to the brake pedal. Thus, if the brake pedal is only lightly touched, only a few of the outer LEDs will light up. On the other hand, if the brake pedal is depressed fully, such as in an emergency braking situation, all of the lights will light up in sequence from the outside towards the middle.

Although the brake light display disclosed by '830 can illuminate in changing way, it's still in the traditional positions of the above-discussed first and second indicators. Moreover, the illumination changing modes of the LEDs are arranged according to the amount of pressure applied to the brake pedal, such that its application is relatively limited then.

Furthermore, the current third brake indicators only have the single function of indicating the braking status of the vehicle on which they are installed. Similar problems haven't been solved when a front car is tuning or is backing. It is still inconvenient for drivers of those following vehicles whose front portions are high or big to see the first and second indicators which indicate the turning or backing status thereof. Possibilities of collisions are thus not avoided completely from this viewpoint.

### SUMMARY OF THE INVENTION

A main object of the present invention is to provide an indicator system which can present various dynamic indicating signals or signs at a conspicuous position especially for warning or reminding vehicles following behind.

A second object of the present invention is to provide a dynamic indicator display at a third indicator position higher than the traditional first and second indicator positions at the opposite sides of the bottom of a vehicle's rear portion.

A third object of the present invention is to provide a multi-functional indicator display at a third indicator position higher than the traditional first and second indicator positions at the opposite sides of the bottom of a vehicle's rear portion.

A fourth object of the present invention is to provide a dynamic indicator display with multi-functions at a third indicator position higher than the traditional first and second indicator positions at the opposite sides of the bottom of a vehicle's rear portion.

A fifth object of the present invention is to provide a new indicator system having a dynamic indicator display with multi-functions positioned at a third indicator position higher than the traditional first and second indicator positions at the opposite sides of the bottom of a vehicle's rear portion.

In order to achieve the objects set forth, the present invention provides an indicator system for a vehicle. The indicator system is in communication with a control system installed within the vehicle and comprises an indicator display. The indicator display is located at a position a certain distance higher than the bottom edge of the vehicle's rear portion, for presenting dynamic signals and/or signs according to different types of instructions by the control system.

The indicator display includes a plurality of rows of lighten units, for example, the incandescent lamps or non-incandescent lamps. In an embodiment of this invention, the lighten units are light emitting diodes (LEDs) which may be switched on selectively in certain orders thereby displaying dynamic signals and/or signs. The dynamic signals and/or signs of the indicator display may be presented in a moving way, for example, the dynamic signals and/or signs are made to be flowing or rolling from an end of the indicator display to the other end thereof.

The indicator display will present a first pattern of the signals and/or signs indicating the turning status of the vehicle when the control system gives correspondent left or right tuning type of instructions to the indicator system. The first pattern of the signals and/or signs thereof may be a symbol of an arrow pointing to left or right direction accordingly, or a word or a literal expression pointing out the turning status thereof or other possible patterns.

The indicator display will present a second pattern of the signals and/or signs indicating the braking status of the vehicle when the control system gives correspondent braking instructions to the indicator system. The second pattern of the signals and/or signs thereof may be the plurality of rows of blinking LEDs, or a word or a literal expression pointing out the braking status thereof, or other possible patterns.

The indicator display will present a third pattern of the signals and/or signs indicating the backing status of the vehicle when the control system gives correspondent backing instructions to the indicator system. The third pattern of the signals and/or signs thereof may be a symbol of “!” for warning vehicles or people behind it that the vehicle is backing, or a word or a literal expression pointing out the backing status thereof, or and other possible patterns.

The indicator display will present a fourth pattern of the signals and/or signs indicating the turning and braking status of the vehicle according to correspondent instructions of the control system when the vehicle is turning and braking in the mean time. The fourth pattern of the signals and/or signs thereof includes a symbol of an arrow pointing to left or right direction accordingly and a plurality of blinking LEDs right above the dynamic arrow symbol. The arrow symbol and the blinking LEDs may be shown in different colors by making the corresponding LEDs to emit light in different colors.

The position of the indicator display is located around the middle section of the rear portion of the vehicle. The indicator display may be located at a position approaching the bottom of the vehicle's rear window. The indicator display may be located just below the roof of the vehicle. The indicator display is installed within the vehicle and can be seen through the rear window thereof. The indicator display may be located around the middle section of the trunk or on the rear section of the wing.

Other objects, advantages and novel features of the invention will become more apparent from the following detailed description when taken in conjunction with the accompanying drawings.

### BRIEF DESCRIPTION OF THE DRAWINGS

FIG. 1 is a rearview of a car equipped with an indicator system in accordance with the present invention;

FIG. 2 is a magnified view of the indicator display of the indicator system in accordance with the present invention;

FIGS. 3A, 3B and 3C are sketching views of the indicator display illustrating the dynamic process thereof in an embodiment;

FIG. 4 is the sketching view of the indicator display in another embodiment; and

FIG. 5 is the sketching view of the indicator display in another embodiment.

### DETAILED DESCRIPTION OF PREFERRED EMBODIMENT

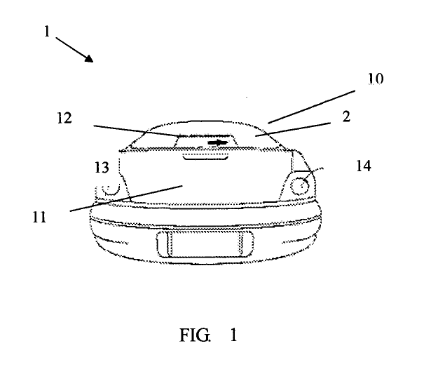

Referring to FIG. 1, the present invention provides an indicator system (not labeled) for a vehicle 1. The vehicle 1 has a body 11, a roof 10 and a rear window 12 between the roof 10 and the rear portion of the body 11. Two sets of traditional turn indicators 13 and 14 are positioned at opposite sides of the rear portion of the body 11 and approach the bottom edge of the rear portion in a conventional way.

The indicator system in accordance with the present invention is in communication with a control system (not shown) installed within the vehicle and comprises an indicator display 2. The indicator display 2 is located at a position a certain distance higher than the bottom edge of the rear portion, actually higher than the positions of the traditional turn indicators 13 and 14. Hence, the indicator display 2 of the present invention is located in a conspicuous position so that it is very easy and convenient to see even for drivers sitting in those vehicles whose front portion are high or big and are following the vehicle 1.

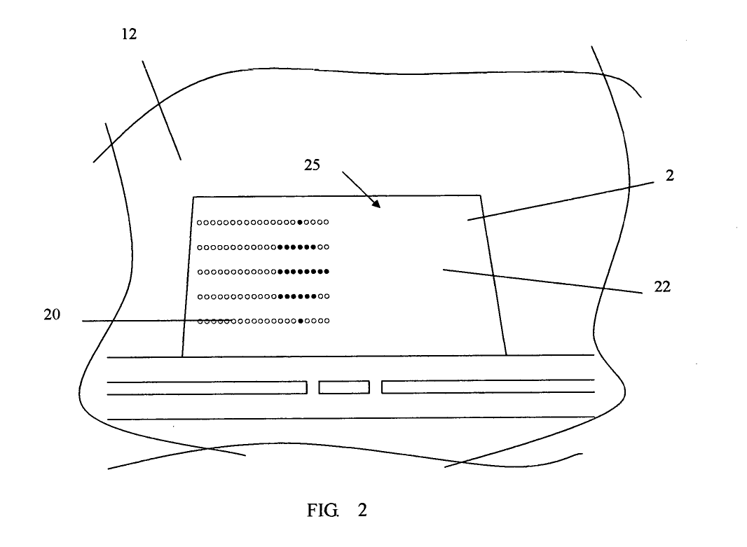

The position of the indicator display 2 can be located around the middle section of the rear portion of the vehicle's body 11. For example, the indicator display 2 may be located at a position approaching the bottom of the vehicle's rear window 12, or in the adjacent area between the rear window 12 and the body 11 as shown in FIGS. 1 and 2. The indicator display 2 may be located just below the roof 10 of the vehicle 1, and/or on the top or upper section of the rear window 12. Normally, the indicator display 2 is installed within the vehicle 1 so that it can be easily to arrange according connections to the control system, and can be seen through the rear window 12 thereof.

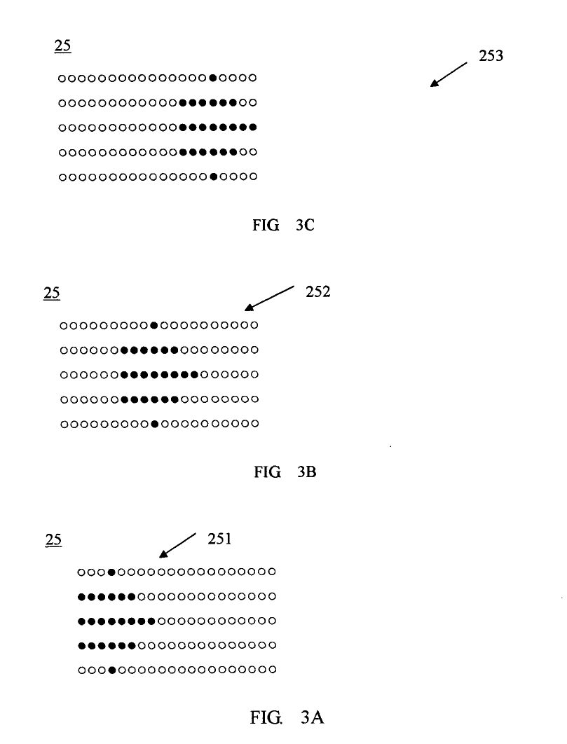

The indicator display 2 includes a plurality of rows of light emitting diodes (LEDs) 20 which may be switched on selectively in certain orders for presenting dynamic signals and/or signs according to different types of instructions by the control system. The dynamic signals and/or signs of the indicator display 2 may be presented in a moving way, for example, the dynamic signals and/or signs are made to be flowing or rolling from an end of the indicator display 2 to the other end thereof as illustrated in FIGS. 3A, 3B and 3C which will be detailed below.

When the driver thereof wants the vehicle 1 to turn right, he will actuate a right-turn switch of the control system which will then immediately send a right-turn instruction to the indicator system of the present invention. Of curse, this process also can be performed automatically by the control system and/or other suitable devices installed in the vehicle 1 without the driver's actuating operation.

Upon receiving the right-turn instruction from the control system, the indicator system will control its indicator display 2 to present a first pattern of the signals and/or signs indicating the turning status of the vehicle 1.

As shown in FIGS. 3A, 3B and 3C, the first pattern 25 of the indicator display 2 is a symbol of an arrow “>” pointing to right direction accordingly. The arrow is dynamic and “flows” or moves from a first position indicated as 251 at the left end of the indicator display 2, to a second position indicated as 252 in the middle of the indicator display 2, and then to a third position indicated as 253 at the right end of the indicator display 2.

So, the dynamic feature of the first pattern 25 of the indicator display 2 is essentially the moving status of the fist pattern 25 in the indicated turning direction by the arrow. The arrow may also be in a blinking status, that is, the LEDs consisting the shape of arrow will be blinking at the same time as the first pattern 25 moves dynamically.

The first pattern 25 can also be in other suitable signs or symbols, like a word or a literal expression which can clearly point out the turning status of the vehicle 1. Also, only the LEDs at the right side or end of the first pattern 25 illuminate to indicate the vehicle is turning in the right direction; and when turn left, the LEDs at the left side of the first pattern 25 illuminate.

When the driver brakes the vehicle 1, the control system will synchronously gives a braking instruction to the indicator system of the present invention. Thus, the indicator display 2 will present a second pattern (not shown) of the signals and/or signs indicating the braking status of the vehicle 1.

The second pattern may be formed by illuminating all LEDs of the indicator display 2, or by only illuminating LEDs of a selected portion of the indicator display 2, just as the pattern 261 shown in FIG. 4.

Alternatively, a word, for example “braking” or a literal expression directly and clearly pointing out the braking status of the vehicle 1, or other suitable patterns, may also be available designs for the second pattern. Such patterns may also be arranged in a dynamic as well as blinking way as detailed above regarding to the first pattern of the indicator display 2.

If the driver intends to back the vehicle 1, he will also actuate an according switch of the control system, so that the indicator system of the present invention will receive corresponding backing instruction from the control system. Hence, the indicator display 2 will present a third pattern of the signals and/or signs indicating the backing status of the vehicle 1.

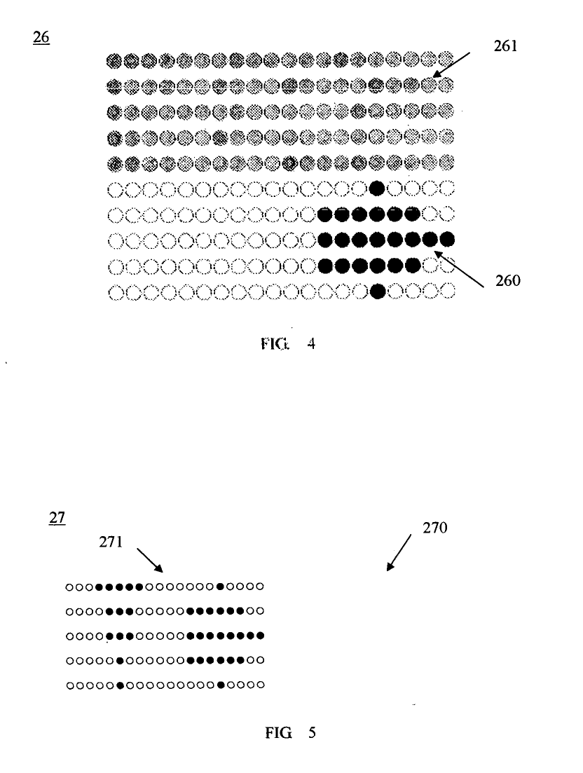

The third pattern may like a symbol 271 of “!” as shown in FIG. 5 for warning other vehicles or people behind it that the vehicle 1 is backing. Alternatively, a word, for example “backing” or a literal expression directly and clearly pointing out the backing status of the vehicle 1, or other suitable patterns, may also be selected as the third pattern. Such patterns may also be arranged in a dynamic as well as blinking way as detailed above regarding to the first pattern of the indicator display 2.

As we know, the driver will commonly brake the vehicle 1 in the mean time when he make a turning operation to the vehicle 1. In order to indicate such a turning and braking status thereof, a fourth pattern of the signals and/or signs of the indicator display is demanded.

Refer to FIG. 4, the fourth pattern 26 may include a pattern 260 of an arrow symbol pointing to left or right direction accordingly and a plurality of blinking LEDs pattern 261 right above the dynamic arrow pattern 260.

Obviously, other alternative combinations of suitable pattern designs may replace the patterns 260 and 261 in FIG. 4 to clearly indicating the turning and braking status of the vehicle 1. For example, FIG. 5 shows another fourth pattern 27 of the indicator display 2 which indicates the turning and braking status of the vehicle 1. The pattern 271 is a dynamic “!” symbol to indicating the speed of the vehicle 1 is decreasing, and the arrow pattern 270 is of course to indicate the vehicle 1 is turning right.

It should be noticed that the dynamic feature of the patterns 25, 26, 27 and others not exampled of the indicator display 2 essentially refers to a moving status thereof. The moving direction may be from the right end to the left end of the indicator display 2, or in the opposite direction which may pre-set according to requirements. The dynamic feature thereof may also include the blinking status of the patterns 25, 26, 27 and other suitable pattern designs.

Moreover, various combinations of the dynamic pattern presented by the indicator display 2 in accordance with the present invention can also be designed to indicate different status in which the vehicle 1 is not simply turning or braking or backing and so on. Instead, the vehicle 1 is in a status with mixed movements or operations like the above-described turning and braking status.

Furthermore, since the LEDs may emit light in different colors, the patterns 260 and 261 shown in FIG. 4, as well as the patterns 270 and 271 shown in FIG. 5 may be in different colors by making the corresponding LEDs to emit light in different colors. For example, the pattern 260 is in red and the pattern 261 is in yellow, or the pattern 270 is in blue and the pattern 271 is in green, and so on.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An indicator system for a vehicle in communication with a control system installed within the vehicle, comprising an indicator display, which is located at a position a certain distance higher than the bottom edge of the vehicle's rear portion, for presenting dynamic signals and/or signs according to different types of instructions of the vehicle by the control system.

2. The indicator system as claimed in claim 1, wherein the indicator display includes a plurality of rows of light emitting diodes (LEDs) which may be switched on selectively in certain orders thereby displaying dynamic signals and/or signs.

3. The indicator system as claimed in claim 2, wherein the dynamic signals and/or signs of the indicator display may be presented in a moving way.

4. The indicator system as claimed in claims 1 or 2 or 3, wherein the indicator display will present a first pattern of the signals and/or signs indicating the turning status of the vehicle when the control system gives correspondent left or right turning type of instructions to the indicator system.

5. The indicator system as claimed in claim 4, wherein the first pattern of the signals and/or signs thereof may be a symbol of an arrow pointing to left or right direction accordingly.

6. The indicator system as claimed in claim 4, wherein the first pattern of the signals and/or signs thereof may be a word or a literal expression pointing out the turning status thereof.

7. The indicator system as claimed in claims 1 or 2 or 3, wherein the indicator display will present a second pattern of the signals and/or signs indicating the braking status of the vehicle when the control system gives correspondent braking instructions to the indicator system.

8. The indicator system as claimed in claim 7, wherein the second pattern of the signals and/or signs thereof may be the plurality of rows of blinking LEDs.

9. The indicator system as claimed in claim 8, wherein the second pattern of the signals and/or signs thereof may be a word or a literal expression pointing out the braking status thereof.

10. The indicator system as claimed in claim 1 or 2 or 3 or 4 or 7, wherein the indicator display will present a third pattern of the signals and/or signs indicating the backing status of the vehicle when the control system gives correspondent backing instructions to the indicator system.

11. The indicator system as claimed in claim 10, wherein the third pattern of the signals and/or signs thereof may be a word or a literal expression pointing out the backing status thereof.

12. The indicator system as claimed in claim 11, wherein the third pattern of the signals and/or signs thereof may be a symbol of “!” for warning vehicles or people behind it that the vehicle is backing.

13. The indicator system as claimed in claim 1 or 2 or 3, wherein the indicator display will present a fourth pattern of the signals and/or signs indicating the turning and braking status of the vehicle according to correspondent instructions of the control system when the vehicle is turning and braking in the mean time.

14. The indicator system as claimed in claim 13, wherein the fourth pattern of the signals and/or signs thereof includes a symbol of an arrow pointing to left or right direction accordingly and a plurality of blinking LEDs right above the dynamic symbol.

15. The indicator system as claimed in claim 14, wherein the dynamic symbol and the blinking LEDs may be shown in different colors by making the corresponding LEDs to emit light in different colors.

16. The indicator system as claimed in claims 1 or 2 or 3 or 4 or 7 or 10 or 13, wherein the position of the indicator display is around the middle section of the rear portion of the vehicle.

17. The indicator system as claimed in claim 16, wherein the indicator display may be located at a position approaching the bottom of the vehicle's rear window.

18. The indicator system as claimed in claim 16, wherein the indicator display may be located just below the roof of the vehicle.

19. The indicator system as claimed in claims 17 or 18, wherein the indicator display is installed within the vehicle and can be seen through the rear window thereof.

20. The indicator system as claimed in claim 16, wherein the indicator display system may be located around the rear section of the wing.

21. The indicator system as claimed in claim 16, wherein the indicator display system may be located around the rear section of the wing.

22. An indicator system for a vehicle in communication with a control device for controlling different status of the vehicle, comprising an indicator arrangement located at a position a certain distance higher than the bottom edge of the vehicle's rear portion, wherein the indicator arrangement presents different dynamic patterns indicating different status according to different types of instructions of the vehicle by the control system.

23. The indicator system as claimed in claim 22, wherein the indicator arrangement includes a plurality of rows of light emitting diodes (LEDs) which may be switched on selectively in certain orders thereby displaying dynamic patterns.

24. The indicator system as claimed in claim 23, wherein the dynamic patterns of the indicator arrangement may be presented in a moving way.

25. The indicator system as claimed in claims 22 or 23 or 24, wherein the indicator arrangement will present a first pattern indicating the turning status of the vehicle when the control system gives correspondent left or right turning type of instructions to the indicator system.

26. The indicator system as claimed in claim 25, wherein the first pattern of the signals and/or signs thereof may be a symbol of an arrow pointing to left or right direction accordingly.

27. The indicator system as claimed in claim 25, wherein the first pattern thereof may be a word or a literal expression pointing out the turning status thereof.

28. The indicator system as claimed in claims 22 or 23 or 24, wherein the indicator arrangement will present a second pattern indicating the braking status of the vehicle when the control system gives correspondent braking instructions to the indicator system.

29. The indicator system as claimed in claim 28, wherein the second pattern thereof may be the plurality of rows of blinking LEDs.

30. The indicator system as claimed in claim 28, wherein the second pattern may be a word or a literal expression pointing out the braking status thereof.

31. The indicator system as claimed in claim 22 or 23 or 24, wherein the indicator arrangement nt a third pattern indicating the backing status of the vehicle when the control system gives correspondent backing instructions to the indicator system.

32. The indicator system as claimed in claim 31, wherein the third pattern thereof may be a symbol of “!” for warning vehicles or people behind it that the vehicle is backing.

33. The indicator system as claimed in claim 31, wherein the third pattern thereof may be a word or a literal expression pointing out the backing status thereof.

34. The indicator system as claimed in claims 22 or 23 or 24 or 25 or 28 or 31, wherein the position of the indicator arrangement is around the middle section of the rear portion of the vehicle.

35. The indicator system as claimed in claim 34, wherein the indicator arrangement may be located at a position approaching the bottom of the vehicle's rear window.

36. The indicator system as claimed in claim 34, wherein the indicator arrangement may be located just below the roof of the vehicle.

37. The indicator system as claimed in claims 35 or 36, wherein the indicator arrangement is installed within the vehicle and can be seen through the rear window thereof.

38. The indicator system as claimed in claim 34, wherein the indicator display system may be located around the rear section of the trunk.

39. The indicator system as claimed in claim 34, wherein the indicator display system may be located around the rear section of the wing.

40. The indicator system as claimed in claim 22 or 23 or 24, wherein the indicator arrangement will present a fourth pattern indicating the turning and braking status of the vehicle according to correspondent instructions of the control system when the vehicle is turning and braking in the mean time.

41. The indicator system as claimed in claim 40, wherein the fourth pattern thereof includes a symbol of an arrow pointing to left or right direction accordingly and a plurality of blinking LEDs right above the dynamic arrow symbol.

42. The indicator system as claimed in claim 41, wherein the arrow symbol and the blinking LEDs may be shown in different colors by making the corresponding LEDs to emit light in different colors.

43. An indicator device for a vehicle in communication with a control device for controlling different status of the vehicle, comprising a plurality of light emitting diodes (LEDs) arranged in rows, wherein the LEDs are located at a position a certain distance higher than the bottom edge of the vehicle's rear portion and presents different dynamic patterns indicating different status according to different types of instructions of the vehicle by the control system.

44. The indicator device as claimed in claim 43, wherein the dynamic patterns of the indicator device may be presented in a moving way.

45. The indicator device as claimed in claims 43 or 44, wherein the indicator device will present a first pattern indicating the turning status of the vehicle when the control system gives correspondent left or right turning type of instructions to the indicator system.

46. The indicator device as claimed in claim 45, wherein the first pattern thereof may be a symbol of an arrow pointing to left or right direction accordingly.

47. The indicator device as claimed in claim 45, wherein the first pattern thereof may be a word or a literal expression pointing out the turning status thereof.

48. The indicator device as claimed in claims 43 or 44 or 45, wherein the indicator device will present a second pattern indicating the braking status of the vehicle when the control system gives correspondent braking instructions to the indicator system.

49. The indicator device as claimed in claim 48, wherein the second pattern thereof may be the plurality of rows of blinking LEDs.

50. The indicator device as claimed in claim 48, wherein the second pattern thereof may be a word or a literal expression pointing out the braking status thereof.

51. The indicator device as claimed in claim 43 or 44 or 45 or 48, wherein the indicator device will present a third pattern indicating the backing status of the vehicle when the control system gives correspondent backing instructions to the indicator system.

52. The indicator device as claimed in claim 51, wherein the third pattern thereof may be a symbol of “!” for warning vehicles or people behind it that the vehicle is backing.

53. The indicator device as claimed in claim 51, wherein the third pattern thereof may be a word or a literal expression pointing out the backing status thereof.

54. The indicator device as claimed in claim 43 or 44, wherein the indicator device will present a fourth pattern indicating the turning and braking status of the vehicle according to correspondent instructions of the control system when the vehicle is turning and braking in the mean time.

55. The indicator device as claimed in claim 54, wherein the fourth pattern thereof includes a symbol of an arrow pointing to left or right direction accordingly and a plurality of blinking LEDs right above the dynamic arrow symbol.

56. The indicator device as claimed in claim 55, wherein the arrow symbol and the blinking LEDs may be shown in different colors by making the corresponding LEDs to emit light in different colors.

57. The indicator device as claimed in claims 43 or 44 or 45 or 48 or 51 or 54, wherein the position of the indicator device is around the middle section of the rear portion of the vehicle.

58. The indicator device as claimed in claim 57, wherein the indicator device may be located at a position approaching the bottom of the vehicle's rear window.

59. The indicator device as claimed in claim 57, wherein the indicator device may be located just below the roof of the vehicle.

60. The indicator device as claimed in claims 58 or 59, wherein the indicator device is installed within the vehicle and can be seen through the rear window thereof.

61. The indicator system as claimed in claim 57, wherein the indicator display system may be located around the rear section of the trunk.

62. The indicator system as claimed in claim 57, wherein the indicator display system may be located around the rear section of the wing.

63. A multi-function indicator device for a vehicle in communication with a control device for controlling different status of the vehicle, comprising a plurality of light emitting diodes (LEDs) arranged in rows, wherein the LEDs can present different dynamic patterns indicating different status of the vehicle according to different types of instructions by the control system.

64. The multi-function indicator device as claimed in claim 63, wherein the dynamic patterns of the LEDs may be presented in a moving way.

65. The multi-function indicator device as claimed in claims 63 or 64, wherein the indicator device will present a first pattern indicating the turning status of the vehicle when the control system gives correspondent left or right turning type of instructions to the indicator system.

66. The multi-function indicator device as claimed in claim 65, wherein the first pattern thereof may be a symbol of an arrow pointing to left or right direction accordingly.

67. The multi-function indicator device as claimed in claim 65, wherein the first pattern thereof may be a word or a literal expression pointing out the turning status thereof.

68. The multi-function indicator device as claimed in claims 63 or 64 or 65, wherein the indicator device will present a second pattern indicating the braking status of the vehicle when the control system gives correspondent braking instructions to the indicator system.

69. The multi-function indicator device as claimed in claim 68, wherein the second pattern thereof may be the plurality of rows of blinking LEDs.

70. The multi-function indicator device as claimed in claim 68, wherein the second pattern thereof may be a word or a literal expression pointing out the braking status thereof.

71. The multi-function indicator device as claimed in claim 63 or 64 or 65 or 68, wherein the indicator device will present a third pattern indicating the backing status of the vehicle when the control system gives correspondent backing instructions to the indicator system.

72. The multi-function indicator device as claimed in claim 71, wherein the third pattern thereof may be a symbol of “!” for warning vehicles or people behind it that the vehicle is backing.

73. The multi-function indicator device as claimed in claim 71, wherein the third pattern thereof may be a word or a literal expression pointing out the backing status thereof.

74. The multi-function indicator device as claimed in claim 63 or 64, wherein the indicator device will present a fourth pattern indicating the turning and braking status of the vehicle according to correspondent instructions of the control system when the vehicle is turning and braking in the mean time.

75. The multi-function indicator device as claimed in claim 74, wherein the fourth pattern thereof includes a symbol of an arrow pointing to left or right direction accordingly and a plurality of blinking LEDs right above the dynamic arrow symbol.

76. The multi-function indicator device as claimed in claim 75, wherein the arrow symbol and the blinking LEDs may be shown in different colors by making the corresponding LEDs to emit light in different colors.

77. The multi-function indicator device as claimed in claims 63 or 64 or 65 or 68 or 71 or 74, wherein the position of the indicator device is located around the middle section of the rear portion of the vehicle.

78. The multi-function indicator device as claimed in claim 77, wherein the multi-function indicator device may be located at a position approaching the bottom of the vehicle's rear window.

79. The multi-function indicator device as claimed in claim 78, wherein the multi-function indicator device may be located just below the roof of the vehicle.

80. The multi-function indicator device as claimed in claims 78 or 79, wherein the multi-function indicator device is installed within the vehicle and can be seen through the rear window thereof.

81. The indicator system as claimed in claim 77, wherein the indicator display system may be located around the rear section of the trunk.

82. The indicator system as claimed in claim 77, wherein the indicator display system may be located around the rear section of the wing.
